(19) United States
(12) Patent Application Publication
(10) Pub. No.: US 2026/0021625 A1
(43) Pub. Date: Jan. 22, 2026

(54) METHOD FOR PRODUCING A PLASTIC MOULDED PART

(71) Applicant: tooz technologies GmbH, Aalen (DE)

(72) Inventors: Georg MICHELS, Aalen (DE); Joerg PUETZ, Aalen (DE)

(21) Appl. No.: 18/846,621

(22) PCT Filed: Mar. 10, 2023
(86) PCT No.: PCT/EP2023/056156

§ 371 Date: Sep. 12, 2024

(30) Foreign Application Priority Data
Mar. 14, 2022 (DE) 10 2022 105 840.9

(51) Int. Cl. B29C 51/10; B29C 51/26

(52) U.S. Cl. CPC B29C 51/10; B29C 51/262; B29C 2791/007

(57) ABSTRACT

A method for producing a plastic moulded part includes (a) laying down a plastic film onto a main frame such that the plastic film entirely covers a first through-opening and rests on an edge zone of an upper side of the main frame bordering the first through-opening; (b) heating the plastic film lying on the main frame; and (c) applying a fluid pressure medium such that the plastic film is pressed against a tool and thereby shaped into the plastic moulded part. The shaping of the plastic film is carried out in a pressure chamber. The pressure chamber is formed via a wall surrounding the tool pressing the main frame against the plastic film which presses said plastic film against the clamping frame, such that the clamping frame is part of the pressure chamber and the main frame is part of the pressure chamber.

### PRIORITY

This application claims the priority of German patent application DE 10 2022 105 840.9 filed Mar. 14, 2022, which is hereby incorporated herein by reference in its entirety.

### FIELD

The present invention relates to a method of producing a polymer molding and especially a polymer molding for optical applications.

### BACKGROUND

Such polymer moldings can be produced from a polymer film by high-pressure forming (also known as the Niebling process). Such a high-pressure forming operation involves heating the polymer film (frequently above its softening point) and then pressing it by means of high pressure (up to 300 bar and preferably isostatically) against a mold. In this way, it is possible to reproducibly achieve high contour accuracy in impressions (with tolerances of, for example, less than +/−0.4 mm). Further details of such a high-pressure forming operation can be found, for example, in DE 10 2008 050 564 A1.

Since the polymer films used are generally produced via a flat film extrusion process and the final surface structure (for example gloss and thickness) is created by rolling, there can be anisotropic internal stresses. An adverse result of the necessary heating for the high-pressure forming described is then that the heating releases these intrinsic anisotropic stresses and can lead to warpage. Thus, even small corrugations/folds in the heating operation can have the effect that the required accuracy is no longer obtained in the molding operation.

### SUMMARY

An object of the invention is to provide an improved process for producing a polymer molding in which the disadvantages described at the outset can be avoided as far as possible.

The tension frame can fix or clamp the polymer film uniformly in the region of the edge zone and especially along a continuous line around the first through opening, which can effectively prevent unwanted warpage in the course of heating. The edge zone may be defined, for example, as the region of the top side of the base frame, which extends from the edge of the through opening up to a predetermined distance value from the edge of the first through opening. The edge zone can also be defined in that it is the region of the top side of the base frame on which the polymer film lies and in which it is pressed against the top side by the tension frame when the polymer film covers the first through opening.

The first and/or second through opening may especially be circular. However, an oval shape or any other shape is also possible.

The tension frame can press the polymer film against the top side of the base frame along a continuous pathway that surrounds the first through opening.

In particular, the tension frame may have an annular groove that encloses the second through opening. There may be a seal in the groove, which presses against the polymer film. In particular, the annular groove may press against the polymer film in a region that lies above the first through opening.

The groove and/or the seal may be circular or else have any other ring shape, for example square, rectangular, oval, polygonal, or the shape of any other continuous path.

The base frame may have several projecting pins on its top side. The tension frame may have corresponding holes or adjustment holes. In step a), the tension frame may be pushed over the pins by its adjustment holes and hence positioned on the polymer film.

Alternatively, it is possible that the tension frame is positioned between the pins, which serve as stop for the tension frame. In that case, the tension frame may be formed without the corresponding holes or adjustment holes. The function of the stop, rather than by pins, may also be implemented by any other kind of mechanical stop or stop element.

In addition, the tension frame may have a planar or nonplanar bottom side that rests on the polymer film. The formation of the nonplanar bottom side may be implemented such that this achieves better fixing of the polymer film. For instance, the tension frame may have, on the bottom side, in the region of the edge zone, spikes, teeth and/or a rough surface for fixing of the polymer film. The top side of the base frame may be designed to be planar or designed to be nonplanar. The nonplanar top side may be implemented by spikes, teeth and/or a rough surface. This can improve the fixing of the polymer film.

In addition, a clamping means may be provided, which subjects the tension frame to a force that presses the tension frame against the base frame and hence increases the clamping effect already exerted on the polymer film under the weight of the tension frame. The clamping means can be implemented by clamping elements, such as, for example, by a screw connection and/or one or more clamping levers, or else by means of magnetic force.

In the method according to certain embodiments of the invention, there is a pressure chamber in step c), in which the forming of the polymer film is conducted.

For formation of the pressure chamber, a wall surrounding the mold presses the base frame against the polymer film and the latter against the tension frame, such that both the tension frame is part of the pressure chamber and the base frame is part of the pressure chamber.

With the exception of the polymer film, the elements that form the pressure chamber are preferably formed from metal. It is preferable to provide just one (generally annular) seal per separation plane between two metal faces of the metal elements (without taking account of the polymer film), in order to ensure integrity in that separation plane. Thus, for assurance of integrity, the sequence may be metal-seal-metal, metal-seal-polymer film-metal and metal-polymer film-seal-metal.

The annular seal may be circular, oval, square, rectangular, polygonal, or have the shape of any other continuous path.

All the seals described may be produced, for example, from a heat-resistant elastomer (for example fluoro rubber).

In step c), the mold may be provided with a contour, where the forming is achieved in that the fluid pressure medium presses the polymer film against the contour.

The forming in step c) is preferably effected isostatically.

It will be apparent that the features mentioned above and those still to be elucidated below are usable not just in the combinations specified but also in other combinations or on their own, without leaving the scope of the present invention.

The invention will be elucidated in detail hereinafter by working examples with reference to the appended drawings, which likewise disclose features essential to the invention. These working examples serve merely for elucidation and should not be interpreted in a restrictive manner. For example, a description of a working example having a multitude of elements or components should not be interpreted such that all these elements or components are necessary for implementation. Instead, other working examples may also contain alternative elements and components, fewer elements or components, or additional elements or components. Elements or components of different working examples may be combined with one another, unless stated otherwise. Modifications and variations that are described for one of the working examples may also be applicable to other working examples. For avoidance of repetition, identical or mutually corresponding elements in different figures may be given the same reference numerals and not be elucidated again.

### BRIEF DESCRIPTION OF THE DRAWINGS

FIG. 1 shows a section view of a working example of a fixing unit;

FIG. 2 shows a top view of the fixing unit from FIG. 1;

FIG. 3 shows a view of the bottom side of the tension frame from FIG. 1;

FIG. 4 is a schematic diagram of the apparatus for high-pressure forming;

FIG. 5 shows an enlarged section view of the fixing unit positioned on a slide of the high-pressure forming apparatus;

FIG. 6 is a schematic diagram of the heating device of the high-pressure forming apparatus;

FIGS. 7 to 9 are schematic diagrams of the high-pressure device of the high-pressure forming apparatus for elucidation of the isostatic high-pressure forming of the polymer film performed;

FIG. 10 shows a section view of the polymer molding produced;

FIG. 11 shows a section view of a further working example of the fixing unit;

FIG. 12 shows a section view of a further working example of the fixing unit, and

FIG. 13 shows a top view of the fixing unit from FIG. 12;

### DETAILED DESCRIPTION

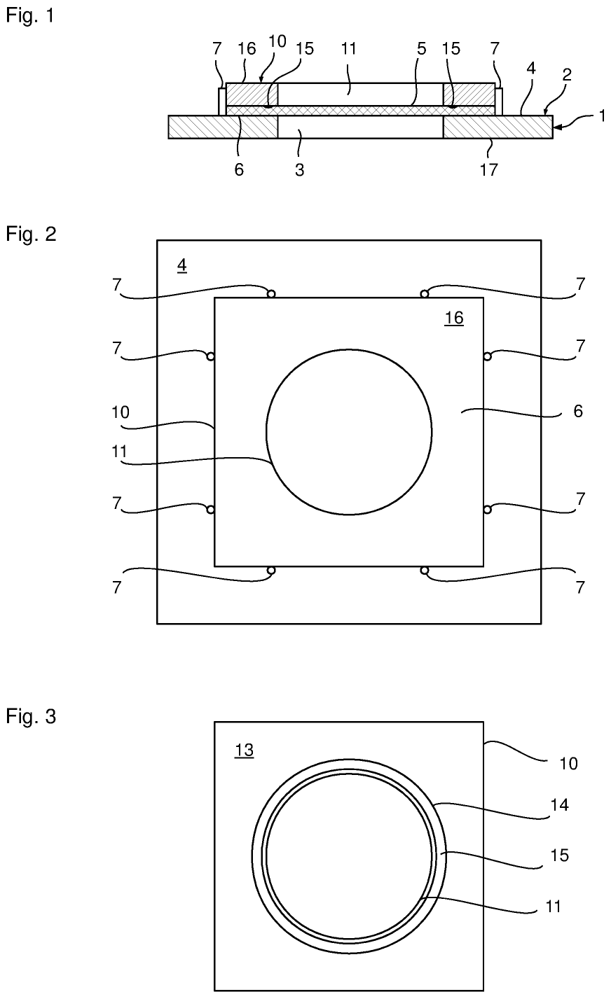

In the working example shown in FIG. 1, the fixing unit 1, for fixing of a polymer film 5 for an apparatus for high-pressure forming, comprises a base frame 2 with a first through opening 3 and a top side 4.

On the top side 4 of the base frame 2 (also called base plate 2 hereinafter), the polymer film 5 is positioned such that it covers the entire first through opening 3 and lies on an edge zone 6 of the top side 4 that bounds the first through opening 3. The first through opening 3 is in circular form, as can be inferred, for example, from the top view in FIG. 2. Of course, different boundary contours of the first through opening 3 are also possible, for example square, rectangular, oval or polygonal.

The base frame 2 comprises eight pins 7 arranged in a rectangle (in a square here) in the edge zone 6, which protrude upward from the top side 4, although other arrangements and/or a different number of pins 7 and geometries other than pins are of course also possible.

The polymer film 5 in the working example described here is square such that it can be placed exactly into the region bounded by the pins 7 on the top side 4 of the base frame 2. By means of additional pins (or other geometries and/or a cutout), unambiguous positioning can also be achieved. This may be advantageous, for example, in the case of preprinted polymer films 5.

Atop the polymer film 5 is positioned a tension frame 10 (FIGS. 1 and 2) that comprises a second circular through opening 11 with a diameter corresponding to the diameter of the first through opening 3 of the base frame 2. The two diameters need not be the same, but may also be different. Of course, different boundary contours of the second through opening 11 are also possible, for example square, rectangular, oval or polygonal. The tension frame 10 is likewise square such that it can be positioned on the polymer film 5 exactly in the region bounded by the pins 7. The tension frame 10 then lies on the polymer film 5 by its bottom side 13 and hence presses it two-dimensionally onto the edge zone 6 of the top side 4 of the base frame 2. The edge zone 6 is thus the region of the top side 4 that extends from the edge of the first through opening 3 as far as the region bounded by the pins 7 on the top side 4.

The pins 7 thus serve firstly to define the position of the polymer film 5 on the base frame 2, and to define the position of the tension frame 10 on the polymer film 5. Secondly, the pins 7 serve as a stop, and ensure that the positions of polymer film 5 and tension frame 10 relative to the base frame 2 and in particular relative to the first through opening 3 of the base frame 2 are reliably maintained, even when the fixing unit 1 is being moved in the apparatus for high-pressure forming, as described hereinafter.

The square shape of the polymer film 5 and of the tension frame 10 is merely illustrative. It is of course also possible to implement different outline contours. What is essential is the two-dimensional and preferably all-round contact of the polymer film 5 with the top side 4 of the base frame 2 because of the tension frame 10 that lies atop the polymer film 5.

As apparent in the section diagram of FIG. 1, the base frame 2 and the tension frame 10 are designed such that, on fixing of the polymer film 5, the two through openings 3, 11 are aligned coaxially to one another.

As can be inferred from FIG. 3 in particular, the bottom side 13 of the tension frame 10 has an annular groove 14 with a greater internal diameter than the diameter of the first through opening 3. In the groove 14 is an annular seal 15 that protrudes beyond the bottom side 13. The seal 15 may be produced from a heat-resistant elastomer, for example FKM (fluoro rubber). As shown in FIG. 1, the seal 15 thus lies on the top side of the polymer film 5 in a region outside the first through opening 3.

In the embodiment described here, both the bottom side 13 and a top side 16 of the tension frame 10 are planar. The polymer film 5 is thus fixed by the weight of the tension frame 10 with which it presses the polymer film 5 against the top side 4 of the base frame 2. The tension frame 10 may have a sheet thickness of 2 mm-50 mm, preferably of 5 mm-10 mm. The sheet thickness of the tension frame 10 may especially be chosen such that the weight of the tension frame 10 is sufficient to assure the desired fixing of the polymer film 5.

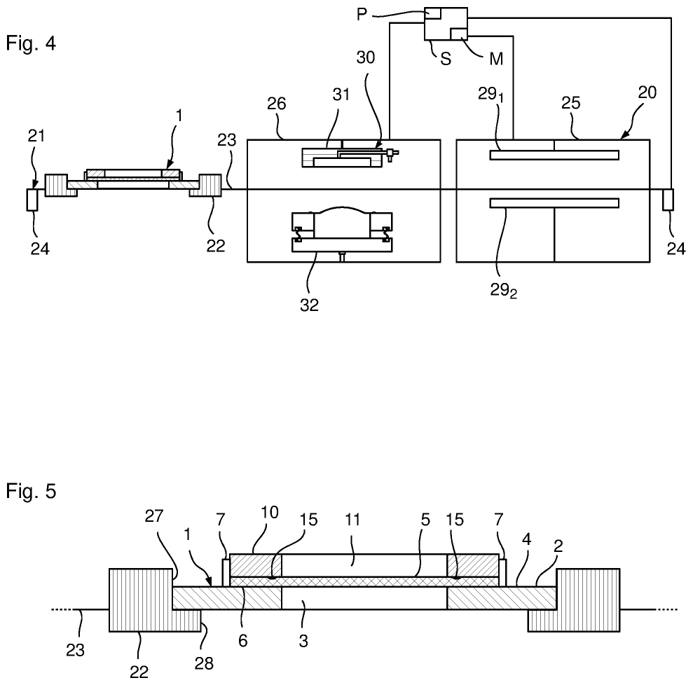

The fixing unit 1 is designed for an apparatus 20 for high-pressure forming, as shown schematically in FIG. 4. The high-pressure forming apparatus 20 comprises a conveying device 21 with a slide 22 for accommodation of the fixing unit 1, a conveyor belt or a conveyor chain 23 and a drive 24, a heating device 25, a high-pressure device 26, and a control unit S for control of the high-pressure forming apparatus 20. The control unit S may comprise, for example, a processor P and a memory M.

In the diagram in FIG. 4 and the enlarged partial diagram in FIG. 5, the slide 22 is in the load/unload position, with the complete fixing unit 1 already placed on the slide 22 or in a depression 27 in the slide 22. In the region of the depression 27, the slide has a third through opening 28 which is larger than the first and second through openings 3, 11, and fully covers the first and second through openings 3, 11, as is readily apparent, for example, in the enlarged diagram in FIG. 5.

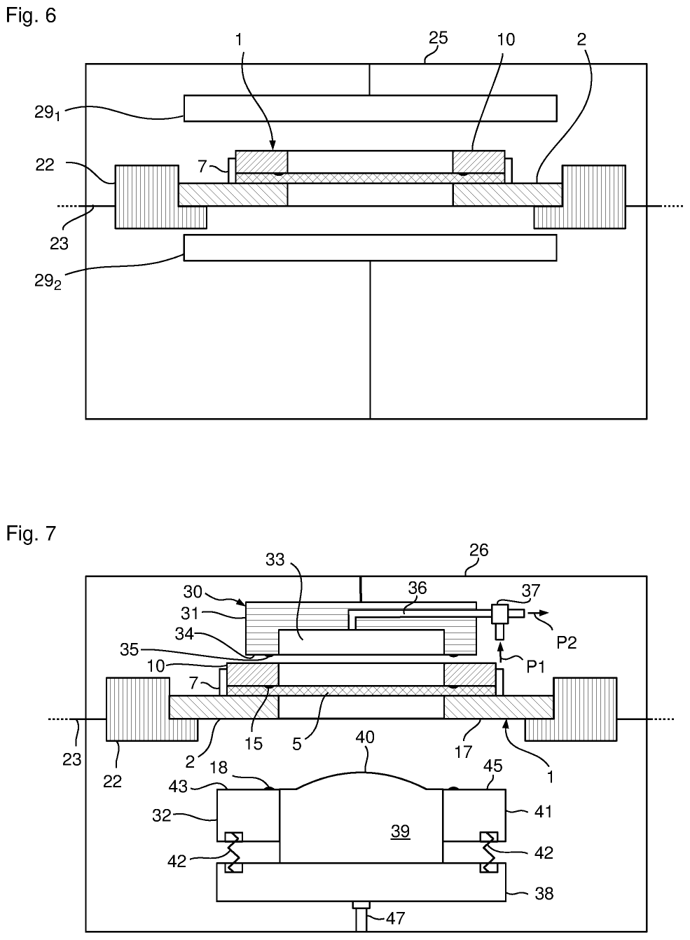

A fixing unit 1 thus secured on the slide 22 can be transported by means of the conveying device 21 into the heating device 25, in which there are disposed, as shown schematically in FIGS. 4 and 6, two actuatable two-dimensional heat sources 291 and 292. The two heat sources 291 and 292 are preferably arranged and/or designed such that they provide the same heating output. For example, if the two-dimensional heat sources 291 and 292 already provide the same heating output, this can be achieved in that they have the same distance from the polymer film 5 in a direction from one heat source 291 to the other heat source 292. However, it is possible in practice for differences to arise through convection, for example, which are then balanced out by controlling the power of the two two-dimensional heat sources 291 and 292.

The heat sources 291 and 292 are used to heat the polymer film 5 fixed in the fixing unit 1 above its softening point. Because of the tension frame 10, the polymer film 5 is not heated with the same intensity in the region of the edge zone 6 as in the region of the through opening 11, such that the film temperature in the edge zone generally remains below the softening point. This leads to a circumferentially stabilized polymer film 5.

The polymer film 5 thus heated is then transported by means of the conveying device 21 into the high-pressure device 26, in which isostatic high-pressure forming is conducted by contacting with a liquid pressure medium.

For this purpose, the high-pressure device 26 comprises a pressure chamber 30 which, as described below, can be opened and closed. The pressure chamber 30 comprises a first and second subchamber 31 and 32.

The first subchamber 31 forms a pressure dome and is typically disposed at the top, such that the open cavity 33 of the pressure dome faces downward. Moreover, the first subchamber 31 has an annular contact face 34 facing downward, the inner contour of which here is circular and preferably has the same diameter as the second through opening 11 of the tension frame 10. However, it is also possible that the diameter of the inner contour of the annular contact face 34 is somewhat smaller or somewhat larger than the diameter of the second through opening 11 of the tension frame 10. The inner contour of the annular contact face may alternatively have a diameter greater than the diameter of the second through opening 11. At the contact face 34 is disposed an annular seal 35 (for example in an annular groove, not shown) that protrudes from the contact face 34. The annular seal 35 may, for example, be circular, oval, polygonal, or may have the shape of any other continuous path.

The first subchamber 31 contains a channel 36 that opens into the cavity 33 and via which a fluid pressure medium can be supplied and removed again, as indicated by the arrows P1 and P2. For this purpose, a valve 37 is shown in schematic form is provided, which performs the supply and removal of the fluid pressure medium.

The second subchamber 32 comprises a base plate 38 that bears the mold 39 with the desired contour 40 for the polymer film 5. In addition, the second subchamber 32 encompasses a chamber wall 41 which is spring-loaded on the base plate 38 and surrounds the mold 39 laterally. For the spring-loading, the springs 42 shown in schematic form are provided.

The chamber wall 41 has an end 43 pointing upward and having a contact face 45. At the contact face 45 is disposed an annular seal 18 (for example in an annular groove, not shown) that protrudes from the contact face 45. The annular seal 18 may, for example, be circular, oval, polygonal, or may have the shape of any other continuous path.

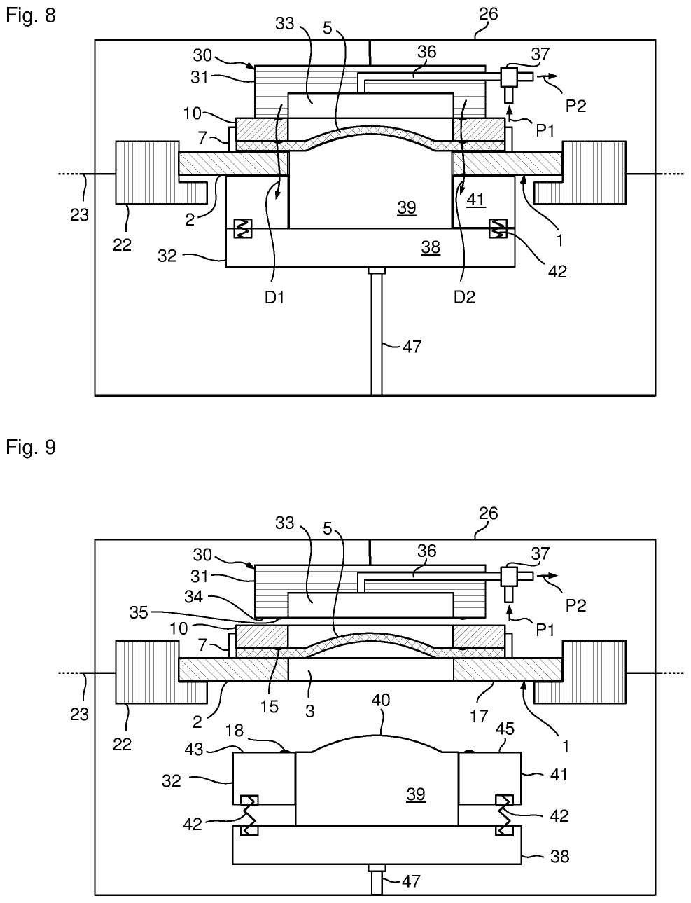

In the representation shown by FIG. 7, the pressure chamber 30 is shown in its open position, in which the slide 22 with the fixing unit 1 can be positioned between the two subchambers 31 and 32. As soon as the slide 22 is appropriately positioned, it is possible by means of a lift device 47 to move the second subchamber 32 upward in the direction of the first subchamber 31, as a result of which the second subchamber 32 presses by means of the contact face 45 against the bottom side 17 of the base frame 2 and hence lifts the base frame 2 with the polymer film 5 and the tension frame 10 off the slide 22 and presses it against the contact face 34 of the first subchamber 31. This results in the desired sealing of the closed pressure chamber 30, as indicated by arrows D1 and D2. At the same time, the mold 39 is moved upward relative to the chamber wall 41 by means of the lift device 47 in that the base plate 38 has been brought into contact with a bottom side of the wall 41 against the force of the springs 42. As a result, the mold 39 with its contour 40 is already in contact with the polymer film 5 (as shown in FIG. 8) or has a small distance from the polymer film 5.

In this closed position of the pressure chamber 30 shown in FIG. 8, the fluid pressure medium is guided into the cavity 33 via the channel 36, giving rise to a positive pressure that leads to isostatic deformation of the polymer film 5, which is thus pressed against the contour 40 of the mold 39.

Thereafter, the fluid pressure medium is removed from the cavity 33 and, to the extent necessary, sufficient cooling of the deformed polymer film 5 is awaited with the pressure chamber 30 closed.

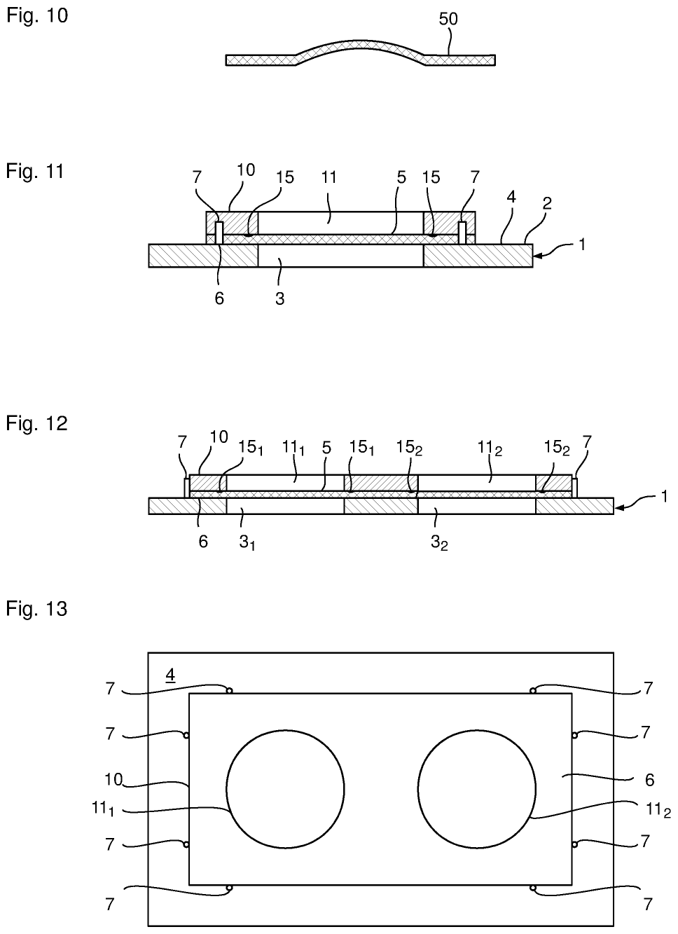

The performance of this deformation of the polymer film 5 results in the desired polymer molding 50, and the pressure chamber 30 is returned to its open position (FIG. 9). The fixing unit 1 is laid back on the slide 22 here, and is transported back to the load/unload position together with the deformed polymer film 5. Thus, a polymer molding 50 (FIG. 10) has been produced from the polymer film 5 in the manner described.

In all movements of slide 22, the pins 7 serve to ensure that the polymer film 5 and the tension frame 10 retain their position.

Since the polymer film 5 is positioned in the fixing unit 1 both in the course of heating and in the course of deforming, the polymer film 5 is always fixed or clamped in the edge zone 6 around the entire first through opening 3, such that warpage of the shape of the polymer film 5 can be very substantially prevented in the course of heating above the softening point and in the course of deforming. When the polymer film 5, as shown in FIG. 8, has been lifted lying on the base frame 2, the desired fixing is achieved by the contact face 45, which presses the polymer film 5 against the bottom side 13 of the tension frame 10 by means of the base plate 2. Such warpage would therefore occur especially because the polymer films 5 used are generally produced via an extrusion process (e.g. flat film extrusion process) and processed further via rolls in order to establish film thickness and surface quality. This leads to intrinsic anisotropic stresses in the material that are released on heating and would then lead to unwanted warpage in a variant known to date, where the polymer film 5 is merely placed on the base frame 2 and no tension frame 10 is provided.

In the working example described so far, the polymer film 5 is fixed mainly by means of the weight of the tension frame 10 lying on top. However, it is additionally or alternatively possible, by means of spikes, teeth and/or a rough surface, to achieve the desired fixing, where the spikes, teeth and/or the rough surface may be formed on the top side 4 of the base frame 2 and/or on the bottom side 13 of the tension frame 10. It is also additionally or alternatively possible to implement mechanical screw connection or clamping (by means, for example, of a clamping lever, springs, etc.). Fixing by magnetic forces is also additionally or alternatively possible.

The polymer film may, for example, be a PC film (polycarbonate film). For example, the PC film may be Makrofol DE 1-1 from Covestro Deutschland AG from Germany. The layer thickness of the polymer film 5 (or of the film piece 5) may, for example, be in the range from 10 μm to 3000 μm, from 12 μm to 2000 μm, from 100 μm to 2000 μm, from 150 μm to 1000 μm, from 125 μm to 1000 μm (or 175 μm to 1000 μm), from 125 μm to 750 μm, from 125 μm to 600 μm, from 150 μm to 650 μm and from 250 μm to 600 μm or from 200 μm to 500 μm. In particular, the layer thickness of the polymer film 5 may be in the range from 350 μm to 650 μm or from 375 μm to 500 μm.

In the case of deformation in the high-pressure device 26, the fluid pressure medium can be fed in 2 to 300 bar and preferably at 10 to 100 bar.

Further details of high-pressure deformation can be found, for example, in DE 10 2008 050 564 A1, the contents of which are hereby incorporated here.

The softening temperature of the PC polymer film 5 used may be in the range from 144 to 146° C. In the case of heating above the softening temperature, therefore, a temperature of greater than 146° C. and preferably less than 190° C. is generated in the heating device 25.

Materials used for the polymer film may especially be thermoplastic polymers, for example polycarbonate, PMMA (polymethylmethacrylate), PA (polyamide), PS (polystyrene), PET (polyethylene terephthalate), PEN (polyethylene naphthalate), TAC (cellulose acetate), COP/COC (cycloolefin polymer or copolymer). In addition, it is also possible to use reactive polymer precursors that are partly or fully cured thermally or by radiative hardening during the forming process or in a downstream process step. Examples of these can be found in the field of polyurethane chemistry inter alia. In addition, it is possible to use coated and/or pretreated films, co-extruded films, hybrid films and/or composite films.

After the the forming step described, further steps may be conducted in order to obtain a desired end product from the polymer molding 50. In particular, it is possible, for example, to conduct a stamping step, a coating step, etc. It is of course also possible that the polymer molding 50 itself is the desired end product.

Since the fixing unit 1 is provided as a separate unit that has to be placed on the slide 22 in the load/unload position, the fixing unit 1 may be loaded externally and then placed into the high-pressure deformation apparatus 20 as a unit and removed again after the deforming. When the tension frame 10 takes the form of a pure lay-on frame (for example with sealing ring 15), incorporation into the fixing unit 1 and deinstallation from the fixing unit 1 can be effected in a rapid and uncomplicated manner without any significant effect on the existing process. The handling steps with regard to the polymer film 5 are minimized, which also leads to lower contamination.

However, it is also possible to dispose the base frame 2 directly in the slide 22 in the loading/unloading station and only to place on the polymer film 5 and the tension frame 10 in the manner described. On completion of forming, the tension frame 10 can be lifted off and the polymer molding 50 formed can be removed. Thereafter, a new polymer film 5 and the tension frame 10 on top can be placed on again, such that a further forming process can be conducted.

In addition, it is possible to conduct automation, for example in such a way that the laying of the polymer film 5 and of the tension frame 10 onto the base frame and the removal of the formed polymer molding 50 after the forming is conducted in an automated manner after the tension frame 10 has been lifted off.

FIG. 11 shows a modification of the fixing unit 1. In this modification, the polymer film 5 and the tension frame 10 are placed onto the pins 7. For this purpose, the polymer film 5 has through openings and the tension frame 10 has corresponding blind holes or through holes.

FIGS. 12 and 13, in the same way as FIGS. 1 and 2, show a modification of the fixing unit 1. In this modification, the base frame 2 has two through openings 31 and 32. In the same way, the tension frame 10 has two through openings 111 and 112 and two seals 151 and 152. Such a fixing unit 1 can double throughput in the forming operation, since it is always possible to produce two polymer moldings 50. For this purpose, the apparatus 20 for high-pressure forming is of course correspondingly adapted. For instance, in the heating device 25, the polymer film 5 can be heated such that the regions in both through openings 111 and 112 of the polymer film are heated in the manner described. There are then two pressure chambers 30 (one each for each pair of through openings 31, 111 and 32 and 112) in the high-pressure apparatus 26.

It is of course also possible to provide only one pressure chamber 30 for both pairs of through openings 31, 111 and 32, 112. In addition, it is possible to provide identical or different molds 39 with identical or different contours 40. It is of course also possible to provide more than two pairs of through openings.

While the invention has been described in connection with what is presently considered to be the most practical and preferred embodiments, it will be apparent to those of ordinary skill in the art that the invention is not to be limited to the disclosed embodiments. It will be readily apparent to those of ordinary skill in the art that many modifications and equivalent arrangements can be made thereof without departing from the spirit and scope of the present disclosure, such scope to be accorded the broadest interpretation of the appended claims so as to encompass all equivalent structures and products. Moreover, features or aspects of various example embodiments may be mixed and matched (even if such combination is not explicitly described herein) without departing from the scope of the invention.

1-9. (canceled)

10. A method of producing a polymer molding, comprising:
(a) placing a polymer film onto a base frame having a first through opening such that the polymer film fully covers the first through opening and lies on an edge zone of a top side of the base frame that bounds the first through opening;
(b) heating the polymer film lying on the base frame; and
(c) contacting the polymer film that lies on the base frame, which has been heated in step (b), with a fluid pressure medium such that the polymer film is pressed against a mold and hence formed into the polymer molding,
wherein a tension frame having a second through opening is positioned in step (a) on the polymer film lying on the base frame such that the tension frame presses and hence fixes the polymer film against the top side of the base frame in the region of the edge zone, and in that the second through opening of the tension frame lies at least partly opposite the first through opening of the base frame,
wherein step (b) is conducted with the polymer film fixed between the base frame and the tension frame,
wherein the forming of the polymer film in step (c) is conducted in a pressure chamber, and
wherein the pressure chamber is formed via a wall surrounding the mold that presses the base frame against the polymer film and hence the latter against the tension frame, such that both the tension frame is part of the pressure chamber and the base frame is part of the pressure chamber.

11. The method of claim 10, wherein the forming in step (c) is conducted isostatically.

12. The method of claim 10, wherein the tension frame in steps (a) and (b) presses the polymer film against the top side of the base frame along a continuous pathway that surrounds the first through opening.

13. The method of claim 10, wherein the tension frame has an annular groove that surrounds the second through opening and in which there is a seal that presses against the polymer film in steps (a) and (b).

14. The method of claim 10, wherein the base frame comprises multiple stop elements that protrude from its top side, and wherein both the polymer film and the tension frame are positioned between the protruding stop elements in step (a).

15. The method of claim 10, wherein the tension frame has a planar bottom side which lies atop the polymer film after performance of step (a).

16. The method of claim 10, wherein the tension frame and/or the base frame, in the region of the edge zone, comprises spikes, teeth and/or a rough surface for fixing of the polymer film.

17. The method of claim 10, wherein a clamping means is provided, which subjects the tension frame to a force that presses the tension frame against the base frame and hence increases the clamping effect already exerted on the polymer film under the weight of the tension frame.

18. A high-pressure forming apparatus, comprising:
a conveying device;
a heating device; and
a high-pressure device,
wherein the conveying device is configured to transport a fixing unit into the heating device and the high-pressure device,
wherein the fixing unit comprises:
a base frame including a first through opening and a top side; and
a tension frame having a second through opening,
wherein a polymer film is placed onto the base frame such that it fully covers the first through opening and lies on an edge zone of the top side of the base frame that bounds the first through opening,
wherein the tension frame lies on the polymer film such that it is pressed and hence fixed in the region of the edge zone against the top side of the base frame, and that the second through opening of the tension frame is at least partly opposite the first through opening in the base frame,
wherein the high-pressure device is configured such that the polymer film heated by the heating device can be contacted with a fluid pressure medium in a pressure chamber such that the polymer film is pressed against a mold and hence formed into a polymer molding, and
wherein the pressure chamber is formed via a wall surrounding the mold that presses the base frame against the polymer film and hence the latter against the tension frame, such that both the tension frame is part of the pressure chamber and the base frame is part of the pressure chamber.
